(19) United States
(12) Patent Application Publication
(10) Pub. No.: US 2015/0365045 A1
(43) Pub. Date: Dec. 17, 2015

(54) SOLAR COLLECTOR ASSEMBLY

(71) Applicant: Solaflect Energy, Inc., Norwich, VT (US)

(72) Inventors: DANIEL SCHNEIDER, Norwich, VT (US); Nathan Hine, South Strafford, VT (US); Mark Drabick, Orford, NH (US)

(21) Appl. No.: 14/740,719

(22) Filed: Jun. 16, 2015

Related U.S. Application Data
(60) Provisional application No. 62/012,635, filed on Jun. 16, 2014.

(51) Int. Cl. H02S 20/30

(52) U.S. Cl. CPC H02S 20/30

(57) ABSTRACT

A solar collector assembly includes a lower structure portion configured to be affixed to/rest upon a foundation. An upper structure portion is configured to mount one or more solar element assemblies. A hinge assembly is configured to rotatably couple the upper structure portion to the lower structure portion.

### RELATED APPLICATION

This application claims the benefit of U.S. Provisional Application No. 62/012,635 filed on 16 Jun. 2014, entitled “System for Raising and Lowering Pole-Mounted Devices Using A Gin Pole”, the contents of which are incorporated herein by reference.

### TECHNICAL FIELD

This disclosure relates to collapsible assemblies and, more particularly, to collapsible assemblies configured to support solar element assemblies.

### BACKGROUND

Currently, a considerable portion of the energy consumed worldwide is generated through the consumption of fossil fuels. Unfortunately and as is well documented, fossil fuels are a nonrenewable resource and have adverse side effects concerning the environment (e.g. the generation of land-based pollution/contamination and the production of greenhouse gases during consumption).

Accordingly, various alternative energy sources are being explored, one example of which is solar energy. Through the use of solar collector assemblies, various solar elements (e.g. mirrors designed to focus the sun's energy to a specific area or photovoltaic cells designed to convert the sun's energy into electricity) may be aimed towards the sun so that they may capture the energy provided by this abundant and clean fuel source.

Unfortunately, such solar collector assemblies may need to be substantially high, wherein the various solar elements are positioned at the top of these assemblies. This, in turn, may create difficulties with respect to servicing these solar elements. Traditionally, ladders and/or scaffolding assemblies may have been used to gain access to these solar elements, often resulting in hazardous work environments and the various downsides associated with the same.

### SUMMARY OF DISCLOSURE

In one implementation, a solar collector assembly includes a lower structure portion configured to be affixed to/rest upon a foundation. An upper structure portion is configured to mount one or more solar element assemblies. A hinge assembly is configured to rotatably couple the upper structure portion to the lower structure portion.

One or more of the following features may be included. The one or more solar element assemblies may include one or more reflective solar element assemblies. The one or more solar element assemblies may include one or more photovoltaic solar element assemblies. The hinge assembly may be a lockable hinge assembly that may be configured to effectuate the locking of the upper structure portion in an erected position with respect to the lower structure portion. The lockable hinge assembly may be configured to receive one or more fastener assembles to effectuate the locking of upper structure portion in the erected position with respect to the lower structure portion. The lockable hinge assembly may include a upper hinge plate coupled to the upper structure portion; and a lower hinge plate coupled to the lower structure portion. The lockable hinge assembly may further include a removable pin assembly configured to rotatably couple the upper hinge plate and the lower hinge plate. The removable pin assembly may be further configured to be removable upon effectuating the locking of the upper structure portion in the erected position with respect to the lower structure portion. One or more of the upper hinge plate and the lower hinge plate may include a convex mating surface. The solar collector assembly may be configured to removably receive a lever assembly configured to assist in rotating the upper structure portion about the hinge assembly and with respect to the lower structure portion. The solar collector assembly may be further configured to removably receive a lifting assembly configured to displace the lever assembly with respect to the lower structure portion. The lifting assembly may be a manual lifting assembly. The lifting assembly may be an electric lifting assembly.

In another implementation, a solar collector assembly includes a lower structure portion configured to be affixed to/rest upon a foundation. An upper structure portion is configured to mount one or more solar element assemblies. A lockable hinge assembly may be configured to rotatably couple the upper structure portion to the lower structure portion and effectuate the locking of the upper structure portion in an erected position with respect to the lower structure portion.

One or more of the following features may be included. The lockable hinge assembly may be configured to receive one or more fastener assembles to effectuate the locking of upper structure portion in the erected position with respect to the lower structure portion. The lockable hinge assembly may include an upper hinge plate coupled to the upper structure portion; a lower hinge plate coupled to the lower structure portion; and a removable pin assembly configured to rotatably couple the upper hinge plate and the lower hinge plate. The removable pin assembly may be further configured to be removable upon effectuating the locking of the upper structure portion in the erected position with respect to the lower structure portion. One or more of the upper hinge plate and the lower hinge plate may include a convex mating surface.

In another implementation, a solar collector assembly includes a lower structure portion configured to be affixed to/rest upon a foundation. An upper structure portion is configured to mount one or more solar element assemblies. A lockable hinge assembly is configured to rotatably couple the upper structure portion to the lower structure portion and effectuate the locking of the upper structure portion in an erected position with respect to the lower structure portion. The solar collector assembly is configured to removably receive a lever assembly configured to assist in rotating the upper structure portion about the lockable hinge assembly and with respect to the lower structure portion.

One or more of the following features may be included. The solar collector assembly may be further configured to removably receive a lifting assembly configured to displace the lever assembly with respect to the lower structure portion. The lifting assembly may be a manual lifting assembly. The lifting assembly may be an electric lifting assembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1A is a diagrammatic front view of a solar collector assembly;

FIG. 1B is a diagrammatic side view of the solar collector assembly of FIG. 1A;

FIGS. 2A-2E are various diagrammatic views of a hinge assembly included within the solar collector assembly of FIGS. 1A-1B;

FIGS. 3A-3B are diagrammatic views of a lever assembly for use with the solar collector assembly of FIGS. 1A-1B;

FIGS. 4A-4D are detail views of the lever assembly of FIGS. 3A-3B;

FIGS. 5A-5C are diagrammatic views showing the operation of the solar collector assembly of FIGS. 1A-1B;

FIG. 6 is a diagrammatic view of a hinge assembly included within the solar collector assembly of FIGS. 1A-1B; and

FIGS. 7A-7C are diagrammatic views of a hinge assembly included within the solar collector assembly of FIGS. 1A-1B.

Like reference symbols in the various drawings indicate like elements.

### DETAILED DESCRIPTION OF THE PREFERRED EMBODIMENTS

### System Overview:

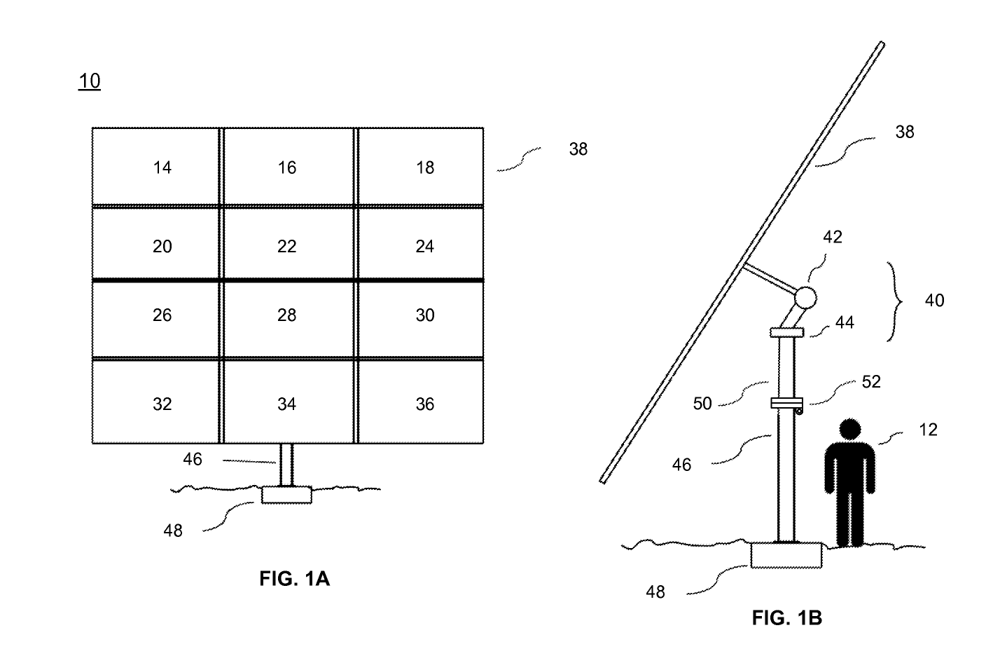

Referring to FIGS. 1A & 1B, there is shown solar collector assembly 10 that may be configured to allow for easier servicing (by technician 12) of the various solar element assemblies (e.g., solar element assemblies 14, 16, 18, 20, 22, 24, 26, 28, 30, 32, 34, 36) that are attached to solar collector assembly 10. Examples of these various solar element assemblies (e.g., solar element assemblies 14, 16, 18, 20, 22, 24, 26, 28, 30, 32, 34, 36) may include but are not limited to one or more reflective solar element assemblies (e.g., for aiming and/or focusing the sun's light onto a remote object, such as within a heliostat) and/or one or more photovoltaic solar element assemblies (e.g., for converting the sun's energy into electricity).

While in this example, solar collector assembly 10 is shown to include twelve solar element assemblies forming array 38 (e.g., a planar array, a curved/troughed array, or a parabolic array), this is for illustrative purposes only and is not intended to be a limitation of this disclosure, as other configurations are possible.

Solar collector assembly 10 may include sun-tracking mechanism 40 that may be configured to move array 38 and may allow for two-degrees of freedom (through the use of first bearing 42 and second bearing 44), thus allowing array 38 to track the movement of the sun with respect to the horizon.

Solar collector assembly 10 may include lower structure portion 46 configured to be affixed to/rest upon foundation 48. Examples of foundation 48 may include but are not limited to a cylindrical concrete pier into/onto which lower support structure 46 is positioned. Solar collector assembly 10 may also include upper structure portion 50 configured to mount one or more solar element assemblies (e.g., solar element assemblies 14, 16, 18, 20, 22, 24, 26, 28, 30, 32, 34, 36). Solar collector assembly 10 may also include hinge assembly 52 configured to rotatably couple upper structure portion 50 to lower structure portion 46.

Hinge assembly 52 may be a lockable hinge assembly that is configured to effectuate the locking of upper structure portion 50 in an erected position with respect to lower structure portion 46. For example, hinge assembly 52 may be configured to allow upper structure portion 50 to be swung into position above/on top of lower structure portion 46 so that solar collector assembly 10 may be used to gather solar energy. Conversely, in the event that the systems/devices/assemblies affixed to upper structure portion 50 of solar collector assembly 10 need to be serviced (e.g., by technician 12), hinge assembly 52 may be configured to be unlocked so that upper structure portion 50 of solar collector assembly 12 may be swung downward (with respect to lower structure portion 46) so that the various systems/devices/assemblies affixed to upper structure portion 50 may be serviced (e.g., by technician 12) and, once the service is complete, upper structure portion 50 may be swung into position above/on top of lower structure portion 46.

Specifically and concerning the manner in which hinge assembly 52 may be locked, hinge assembly 52 may be configured to receive one or more fastener assembles (e.g., a combination of a nut and bolt) that may be used to effectuate the locking of upper structure portion 50 in the erected position with respect to lower structure portion 46.

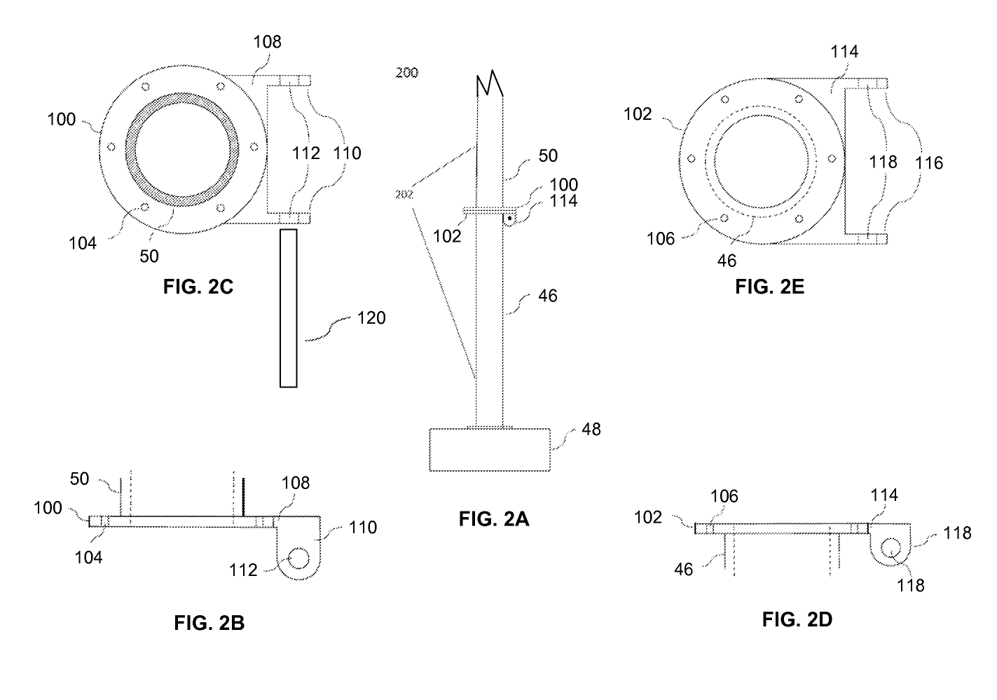

Referring also to FIGS. 2A-2E, hinge assembly 52 may include upper hinge plate 100 (e.g., a first flange) coupled to upper structure portion 50 and lower hinge plate 102 (e.g., a second flange) coupled to lower structure portion 46. Upper hinge plate 100 may be configured in a cylindrical shape and may include a plurality of passages (e.g., passage 104 through which fasteners (e.g., a nut/bolt assembly) may pass. Similarly, lower hinge plate 102 may be configured in a cylindrical shape and may include a plurality of passages (e.g., passage 106 through which fasteners (e.g., a nut/bolt assembly) may pass. Passage 104 may be aligned with passage 106 so that upper hinge plate 100 and lower hinge plate 102 may be releasably fastened together through the use of the above-described fastener.

Upper hinge plate 100 may be configured to include extension assembly 108 that may include plurality of flange assemblies 110 having plurality of passages 112. Similarly, lower hinge plate 102 may be configured to include extension assembly 114 that may include plurality of flange assemblies 116 having plurality of passages 118.

Hinge assembly 52 may further include removable pin assembly 120 that may be configured to rotatably couple upper hinge plate 100 and lower hinge plate 102. Additionally, removable pin assembly 120 may be configured to be removable from hinge assembly 52 upon effectuating the locking of upper structure portion 50 in the erected position with respect to lower structure portion 46. Accordingly, passages 112, 118 may be sized to receive removable pin assembly 120.

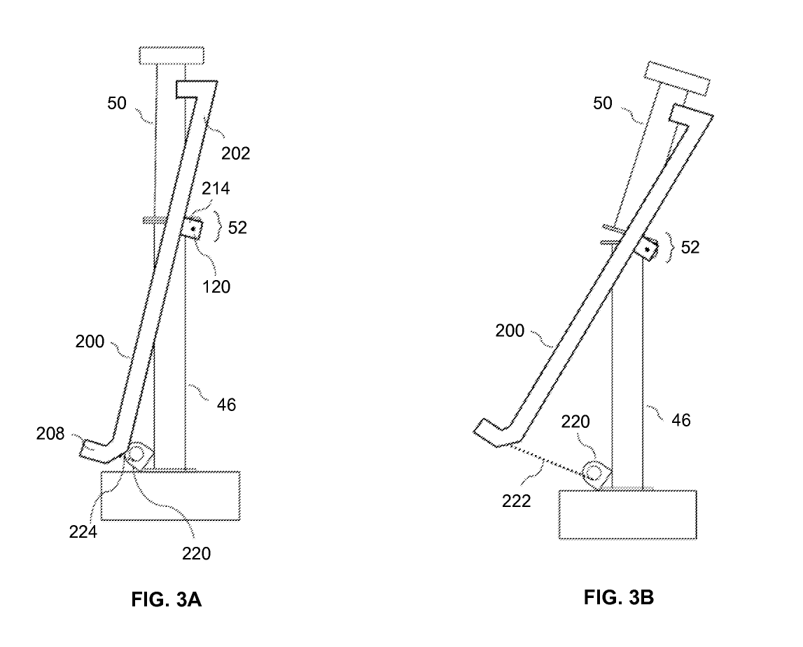

Referring also to FIGS. 3A-3B, solar collector assembly 10 may be configured to removably receive lever assembly 200, wherein lever assembly 200 may be configured to assist in rotating upper structure portion 50 about hinge assembly 52 and with respect to lower structure portion 46.

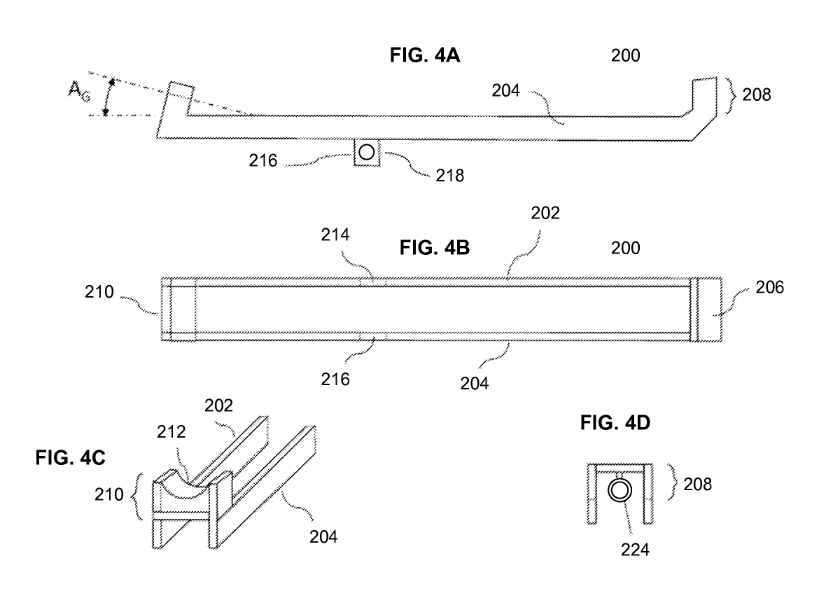

Specifically and referring also to FIGS. 4A-4D, lever assembly 200 may include side bars (e.g., side bars 202, 204) that may be connected on their lower end by kickout cross piece 206 (thus forming raised kickout 208). Side bars 202, 204 may be connected on their upper end by cradle crosspiece 210, which forms cradle 212 (which may be sized/shaped to interface with and partially surround upper structure portion 50).

Lever assembly 200 may further include clevis flanges 214, 216, each of which may include a passage (e.g., passage 218) that may be configured to receive removable pin assembly 120. Accordingly and in such a configuration, lever assembly 200 may be configured to pivot about removable pin assembly 120 included within hinge assembly 52.

While lever assembly 200 is shown to be one unitary piece, this is for illustrative purposes only and is not intended to be a limitation of this disclosure, as other configurations are possible. For example, one or more of sidebars 202, 204 may be removable from lever assembly 200 to allow for the positioning of upper structure portion 50 and/or lower structure portion 46 within the space defined between sidebars 202, 204. As discussed above, solar collector assembly 10 may be configured to removably receive lever assembly 200. Accordingly, lever assembly 200 may be attached to solar collector assembly 10 when technician 12 needs to service solar collector assembly 12 and may be removed from solar collector assembly 10 when service is completed.

As shown in FIGS. 3A-3B, solar collector assembly 10 may be further configured to removably receive lifting assembly 220 that may be configured to displace lever assembly 200 with respect to lower structure portion 46. Examples of lifting assembly 220 may include but are not limited to a manual lifting assembly (e.g., a come-along, a hydraulic jack, a hand crank and gear assembly, and one or more lever assemblies) and an electric lifting assembly (e.g., a battery powered winch assembly, a linear actuated motor, a battery powered motor, and an electrically-actuated gear assembly). Lifting assembly 220 may include cable assembly 222 that may be configured to releasably engage e.g., loop assembly 224 coupled to lever assembly 200. Alternatively, lifting assembly 220 may be configured to engage lever assembly 200 in a different fashion (e.g., through gears, linkages and/or actuation rods). Since solar collector assembly 10 may be configured to removably receive lifting assembly 222, lifting assembly 222 may be attached to solar collector assembly 10 when technician 12 needs to service solar collector assembly 12 and removed from solar collector assembly 10 when service is completed.

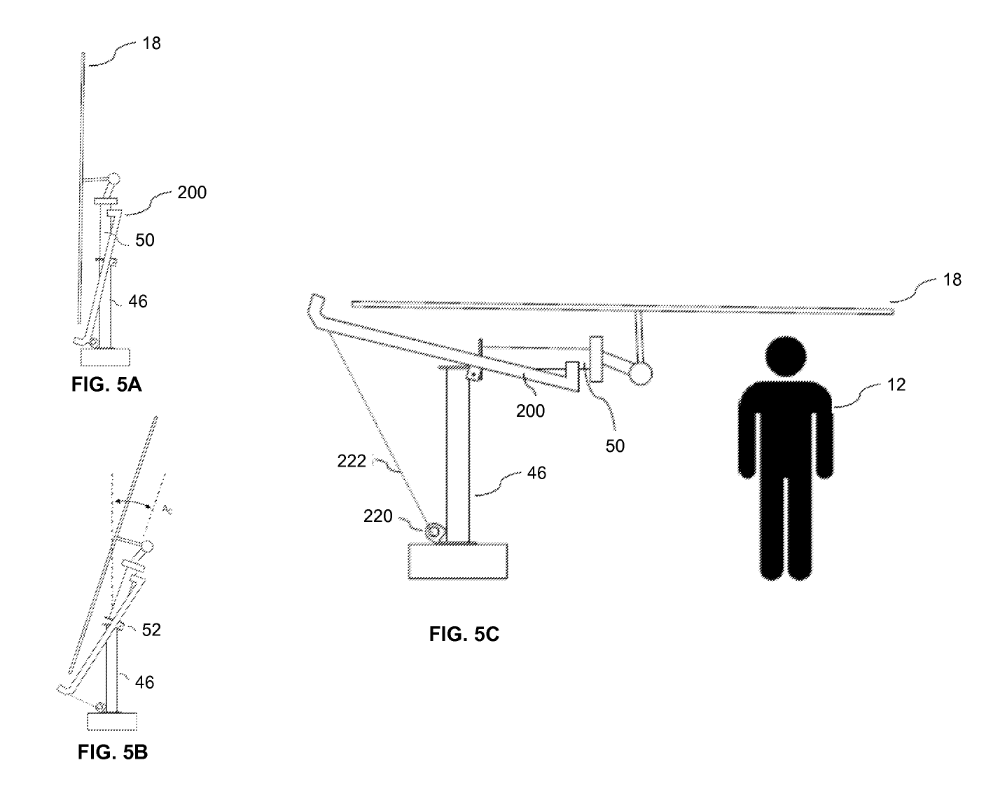

For example and referring also to FIGS. 5A-5C, cradle 212 may be angled (e.g., at angle AG) with respect to sidebars 202, 204, thus allowing for the proper positioning of upper structure portion 50 with respect to lower structure portion 46 during any lifting/servicing operation. Assume for this example that technician 12 needs to replace solar element assembly 18 due to a malfunction/failure and that lifting assembly 220 is a winch assembly that includes cable 222. As shown in FIG. 1A, solar element assembly 18 is one of the upper most solar element assemblies, thus making replacement difficult. However and with the system described above, technician 12 may releasably attach lever assembly 200 to hinge assembly 52 (e.g., using removable pin assembly 120), releasably couple lifting assembly 220 to lower structure portion 46, and may releasably couple cable assembly 222 to loop assembly 224 (included within lever assembly 200). Technician 12 may then remove any fasteners coupling upper hinge plate 100 and lower hinge plate 102. Technician 12 may then use lifting assembly 220 to unwind cable 222 from lifting assembly 220, thus allowing upper structure portion 50 to rotate (in this example) in a clockwise direction around hinge assembly 52 and (in this example) be positioned essentially horizontal (thus greatly simplifying the replacement of solar element assembly 18). Once this service is completed, technician 12 may reverse the above-described procedure to erect upper structure portion 50 upon lower structure portion 46.

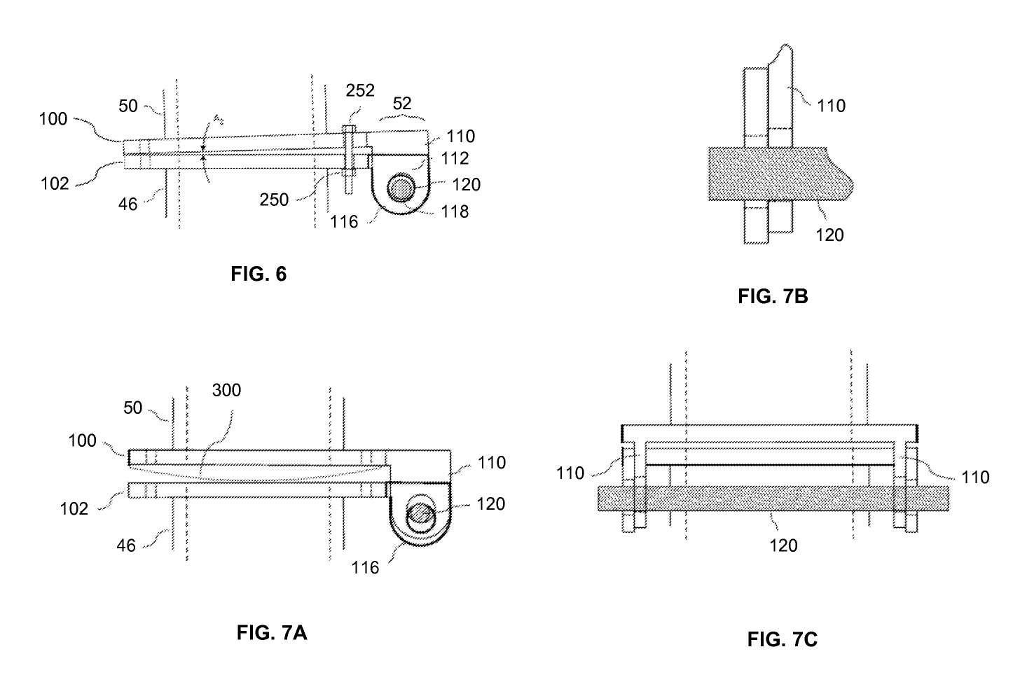

As discussed above and as illustrated in FIG. 6, hinge assembly 52 may be configured to receive one or more fastener assembles (e.g., nut 250 and bolt 252) that may be used to releasably couple upper hinge plate 100 to lower hinge plate 102, thus effectuating the locking of upper structure portion 50 in the erected position with respect to lower structure portion 46

Referring also to FIGS. 7A-7C, one or more of upper hinge plate 100 and lower hinge plate 102 may include a convex mating surface (e.g., convex mating surface 300). Convex mating surface 300 may naturally occur due to e.g., the heat generated by welding upper hinge plate 100 and/or lower hinge plate 102 onto upper structure portion 50 and/or lower structure portion 46 (respectively). Alternatively, convex mating surface 300 may be machined into upper hinge plate 100 and/or lower hinge plate 102. As a result of convex mating surface 300 and through the use of the fastener assemblies (e.g., nut 250 and bolt 252), the passages 112, 118 through flange assemblies 110, 116 (respectively) may become selectively aligned or misaligned, thus allowing for the retention and/or removal of removable pin assembly 120 from hinge assembly 52.

### General:

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A solar collector assembly comprising:
a lower structure portion configured to be affixed to/rest upon a foundation;
an upper structure portion configured to mount one or more solar element assemblies; and
a hinge assembly configured to rotatably couple the upper structure portion to the lower structure portion.

2. The solar collector assembly of claim 1 wherein the one or more solar element assemblies include one or more reflective solar element assemblies.

3. The solar collector assembly of claim 1 wherein the one or more solar element assemblies include one or more photovoltaic solar element assemblies.

4. The solar collector assembly of claim 1 wherein the hinge assembly is a lockable hinge assembly that is configured to effectuate the locking of the upper structure portion in an erected position with respect to the lower structure portion.

5. The solar collector assembly of claim 4 wherein the lockable hinge assembly is configured to receive one or more fastener assembles to effectuate the locking of upper structure portion in the erected position with respect to the lower structure portion.

6. The solar collector assembly of claim 4 wherein the lockable hinge assembly includes:
an upper hinge plate coupled to the upper structure portion; and
a lower hinge plate coupled to the lower structure portion.

7. The solar collector assembly of claim 6 wherein the lockable hinge assembly further includes:
a removable pin assembly configured to rotatably couple the upper hinge plate and the lower hinge plate, wherein the removable pin assembly is further configured to be removable upon effectuating the locking of the upper structure portion in the erected position with respect to the lower structure portion.

8. The solar collector assembly of claim 6 wherein one or more of the upper hinge plate and the lower hinge plate includes a convex mating surface.

9. The solar collector assembly of claim 1 wherein the solar collector assembly is configured to removably receive a lever assembly configured to assist in rotating the upper structure portion about the hinge assembly and with respect to the lower structure portion.

10. The solar collector assembly of claim 9 wherein the solar collector assembly is further configured to removably receive a lifting assembly configured to displace the lever assembly with respect to the lower structure portion.

11. The solar collector assembly of claim 10 wherein the lifting assembly is a manual lifting assembly.

12. The solar collector assembly of claim 10 wherein the lifting assembly is an electric lifting assembly.

13. A solar collector assembly comprising:
a lower structure portion configured to be affixed to/rest upon a foundation;
an upper structure portion configured to mount one or more solar element assemblies; and
a lockable hinge assembly configured to rotatably couple the upper structure portion to the lower structure portion and effectuate the locking of the upper structure portion in an erected position with respect to the lower structure portion.

14. The solar collector assembly of claim 13 wherein the lockable hinge assembly is configured to receive one or more fastener assembles to effectuate the locking of upper structure portion in the erected position with respect to the lower structure portion.

15. The solar collector assembly of claim 13 wherein the lockable hinge assembly includes:
an upper hinge plate coupled to the upper structure portion;
a lower hinge plate coupled to the lower structure portion; and
a removable pin assembly configured to rotatably couple the upper hinge plate and the lower hinge plate, wherein the removable pin assembly is further configured to be removable upon effectuating the locking of the upper structure portion in the erected position with respect to the lower structure portion.

16. The solar collector assembly of claim 15 wherein one or more of the upper hinge plate and the lower hinge plate includes a convex mating surface.

17. A solar collector assembly comprising:
a lower structure portion configured to be affixed to/rest upon a foundation;
an upper structure portion configured to mount one or more solar element assemblies; and
a lockable hinge assembly configured to rotatably couple the upper structure portion to the lower structure portion and effectuate the locking of the upper structure portion in an erected position with respect to the lower structure portion;
wherein the solar collector assembly is configured to removably receive a lever assembly configured to assist in rotating the upper structure portion about the lockable hinge assembly and with respect to the lower structure portion.

18. The solar collector assembly of claim 17 wherein the solar collector assembly is further configured to removably receive a lifting assembly configured to displace the lever assembly with respect to the lower structure portion.

19. The solar collector assembly of claim 18 wherein the lifting assembly is a manual lifting assembly.

20. The solar collector assembly of claim 18 wherein the lifting assembly is an electric lifting assembly.
